(19) United States
(12) Patent Application Publication
(10) Pub. No.: US 2019/0122209 A1
(43) Pub. Date: Apr. 25, 2019

(54) Interoperable Token Issuance and Use in Transaction Processing

(71) Applicant: PayPal, Inc., San Jose, CA (US)

(72) Inventors: Dhaval Bhupendrabhai Shah, San Jose, CA (US); Nitin Prabhu, San Jose, CA (US)

(73) Assignee: PayPal, Inc.

(21) Appl. No.: 16/226,598

(22) Filed: Dec. 19, 2018

Related U.S. Application Data
(63) Continuation-in-part of application No. 15/703,680, filed on Sep. 13, 2017.
(60) Provisional application No. 62/491,946, filed on Apr. 28, 2017.
(60) Provisional application No. 62/422,552, filed on Nov. 15, 2016.

(51) Int. Cl. G06Q 20/38; H04L 9/32

(52) U.S. Cl. CPC G06Q 20/3821; H04L 9/3213

(57) ABSTRACT

The method comprises receiving an onboarding request for a first onboarding process of a first representation of a first user at a token issuance and transaction system, the request received from a transaction system, the request indicating a second onboarding process of a second representation of the first user at the transaction system. The method includes generating, based on performing the first onboarding process and receiving an indication of success of the second onboarding process, a link between the first and second representations at the token issuance and transaction system and the transaction system. The method includes receiving a pre-transaction request from the transaction system, the pre-transaction request indicating a transaction type and the link between the first and second representations. The method also includes determining, based on the link, whether to generate a payment token for completing a requested transaction corresponding to the pre-transaction request.

### RELATED MATTERS

This application claims the benefit of and is a continuation-in-part of U.S. application Ser. No. 15/703,680, titled “Token-based determination of transaction processing resources,” filed on Sep. 13, 2017, the disclosure of which is incorporated herein by reference in its entirety. The Ser. No. 15/703,680 application claims priority benefit of U.S. Provisional Patent Application Ser. No. 62/491,946, titled “Token-Based Determination of Transactions Processing Resources” filed on Apr. 28, 2017. The Ser. No. 15/703,680 application also claims priority benefit of U.S. Provisional Patent Application Ser. No. 62/422,552, titled “Systems and Methods for a Virtual Card Linked to an Account Maintained by a Payment Service Provider” filed on Nov. 15, 2016.

### BACKGROUND

Embodiments of the present disclosure generally relate to the field of communication systems and, more particularly, to interoperable token use in transaction systems.

### BRIEF DESCRIPTION OF THE DRAWINGS

The present embodiments may be better understood, and numerous objects, features, and advantages made apparent to those skilled in the art by referencing the accompanying drawings.

FIG. 1 is a system diagram illustrating embodiments of a communication system showing communication for linking user representations between a token service provider (TSP), a TSP issuance and transaction system, and/or a third-party transaction system.

FIG. 2A is a system diagram illustrating embodiments of a communication system showing communication for interoperable token transactions between a provider, the transaction system, and/or the third-party transaction system.

FIG. 2B is an example process flow for generating and providing a token to third party transaction system.

FIG. 3 is a flow diagram illustrating embodiments of operations for linking user representations for interoperable token use as part of onboarding a user account of one transaction system onto another transaction system.

FIG. 4 is a flow diagram illustrating embodiments of operations for processing a pre-transaction request that includes a link.

FIG. 5 is a timing diagram illustrating establishing communication between transaction systems for interoperable token use.

FIG. 6 is a block diagram of one embodiment of an electronic device used in the communication systems of FIG. 1-5.

### DESCRIPTION OF EMBODIMENT(S)

The description that follows includes exemplary systems, methods, techniques, instruction sequences, and computer program products that embody techniques of the present disclosure. However, it is understood that the described embodiments may be practiced without these specific details. For instance, although some examples refer to online stores, communication with other types of providers of goods and/or services is contemplated, such as online marketplaces and/or auctions. Similarly, although some examples refer to Point-of-Sale (POS) devices, communication with other devices is contemplated, such as with mobile devices and wearables. The described embodiments can be used with other applications that use token services providers and/or token-based authorization of transactions, such as for Single Page Applications (SPAs) and/or Software-as-a-Service (SaaS).

The current disclosure is directed to interoperable token-based transaction processing. The method comprises receiving an onboarding request for a first onboarding process of a first representation of a first user at a token issuance and transaction system, the request received from a transaction system, the request indicating a second onboarding process of a second representation of the first user at the transaction system. The method includes generating, based on performing the first onboarding process and receiving an indication of success of the second onboarding process, a link between the first and second representations at the token issuance and transaction system and the transaction system, respectively. The method includes receiving a pre-transaction request from the second transaction system, the pre-transaction request indicating a transaction type and the link between the first and second representations. The method also includes determining, based on the link, whether to issue a payment token for completing a requested transaction corresponding to the pre-transaction request. The following description, and associated Figures, illustrates various embodiments directed to the ideas listed above.

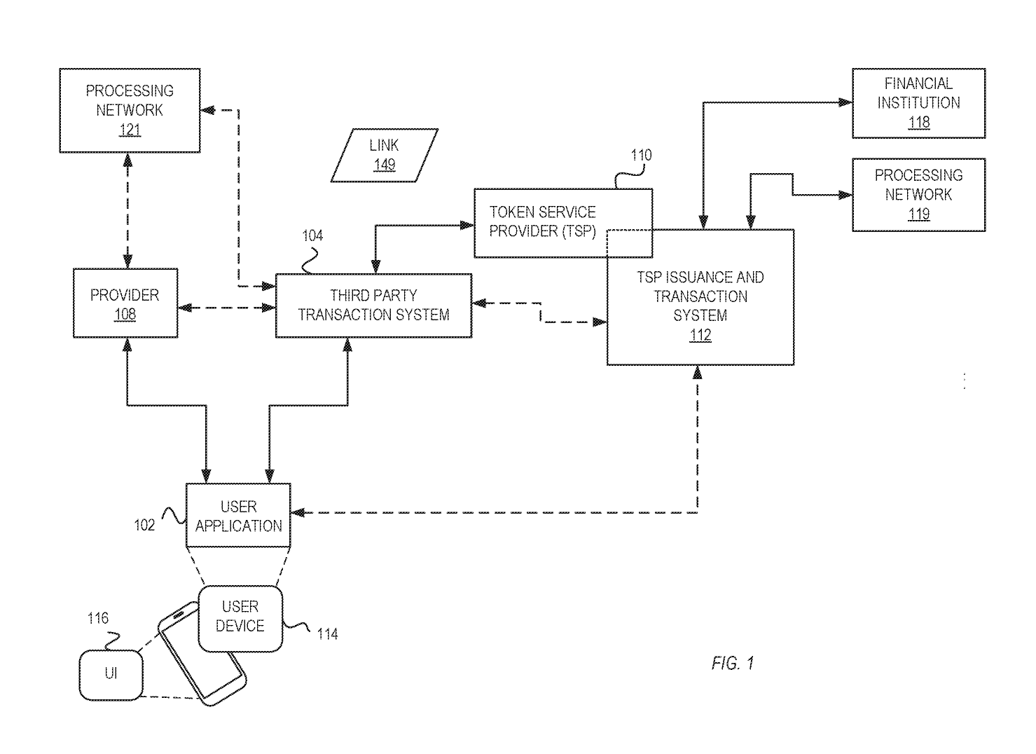

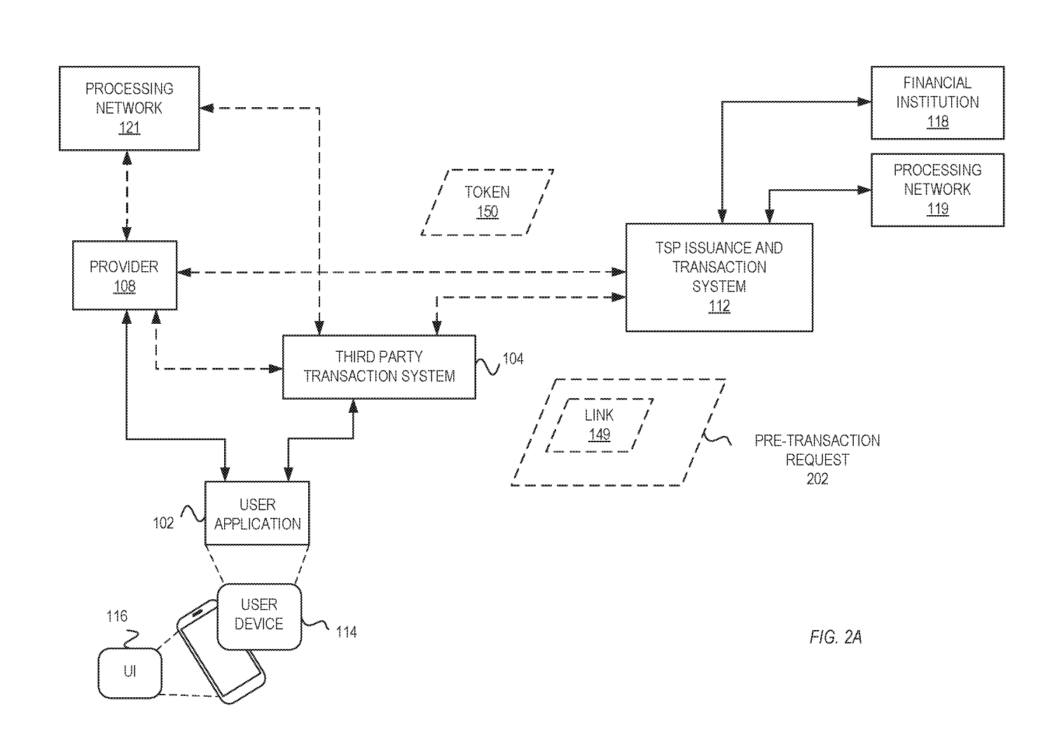

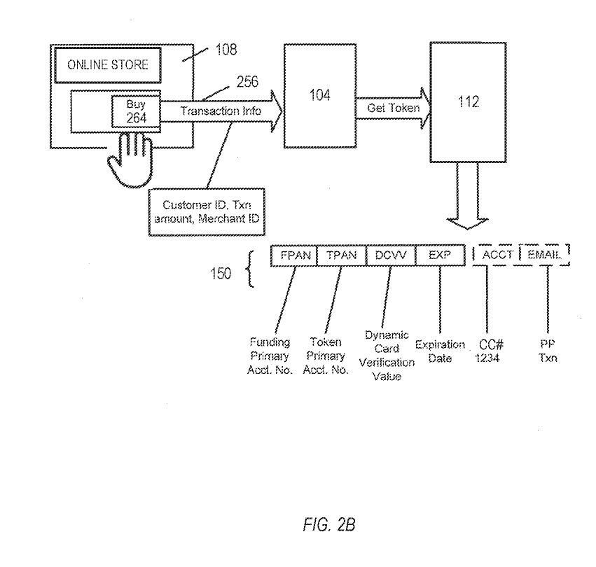

FIG. 1 is a system diagram illustrating embodiments of a communication system showing communication for linking user representations between a token service provider (TSP), a TSP issuance and transaction system, and/or a third-party transaction system. FIG. 1 illustrates a third-party transaction system 104 that communicates with a Token Service Provider (TSP) 110 and a TSP issuance and transaction system 112 to provide certain services to its users, such as a user of a user device 114. FIG. 1 illustrates linking functionality, whereas FIG. 2 illustrates token issuance and processing functionality.

The TSP 110 can provide registration and enrollment functionality (referred to as linking herein) to the third-party transaction system 104. The TSP 110 can facilitate linking of a user representation managed by the third-party transaction system 104 with a user representation, for the same user, at the TSP issuance and transaction system 112. The TSP 110 can be implemented using a PAYPAL TSP. The linking can enable the third-party transaction system 104 to subsequently obtain payment tokens and access certain resources for transactions initiated by its users.

As discussed below with reference to FIG. 2, the third-party transaction system 104 can use the link 149 to request token issuance from the TSP issuance and transaction system 112 for transactions, although some transactions can be completed by the TSP issuance and transaction system 112 without issuing additional tokens. In some embodiments, the third-party transaction system 104 can be implemented as a standalone entity, such as hosted using cloud services, that communicates via a network with the user application 102, the TSP 110, and/or the TSP issuance and transaction system 112. In some embodiments, the third-party transaction system 104 can be implemented as part of the TSP issuance and transaction system 112. For example, the third-party transaction system 104 can be implemented as a container, or another software structure, of the TSP issuance and transaction system 112. In some embodiments, the third-party transaction system 104 can be implemented as part of the user application or the user device. For example, the third-party transaction system 104 can be implemented as part of a trusted execution environment on the user device 114. The third-party transaction system 104 can use Host Card Emulation (HCE), Trusted Execution Environment (TEE), and/or Secure Element (SE) for security on the user device 114.

Tokens may be issued in several different scenarios. In some examples, a token may be issued for online or offline payments. A token may serve as a proxy for a financial instrument or an account with the token service provider. The token may be used for payment purposes, as well as for some non-payment purposes (such as for linking user identities). A token can provide authentication for a certain amount of time, and the token can be used in certain communication sessions. The token can be an encoded value that is generated by the TSP, and can be secure to communicate between the TSP, transaction systems, providers, user applications, etc. A token can be used to indicate authorized access (by a holder of the token) to certain resources at a corresponding transaction system. A token can be used with additional information that further authenticates a user of the token.

In case of payment systems, a token can be associated with one or more instruments that fund transactions performed using this token. Similarly, for SaaS systems, the token can be associated with certain software resources. The token may be implemented as an open loop or closed loop token. The token can serve as a proxy for conveying the user's consent for a particular transaction and for a specific environment. The particular transaction may be a financial or a non-financial transaction corresponding to a specific interaction for that specific environment.

Closed loop tokens typically can only be used by a certain provider/merchant with a certain transaction system. For example, a closed loop token can only be used between the provider 108 (e.g., via the third-party transaction system 104) and the TSP issuance and transaction system 112. As discussed herein, the TSP issuance and transaction system 112 can generate the token based on the link 149 and/or the pre-transaction request. Open loop tokens can typically be used with any provider and/or any payment system that accepts that token. For example, an open loop token can be used for funding a transaction using the processing network 121 (which can be implemented as one of the credit card networks, such as VISA).

Additionally, a token may allow for enablement of specific transaction(s) in the context and parameter set(s) as defined by the user, environment, and/or the TSP 110. An open loop token may refer to an identifier that is sufficiently recognizable to be routable by existing routing networks (e.g., the processing network 121) back to the TSP issuance and transaction system 112, or other such appropriate ecosystems, based on context of the requested transaction. A closed loop token may refer to an identifier that is recognized only by the TSP issuance and transaction system 112 or a limited ecosystem based on business needs.

The TSP issuance and transaction system 112 may issue a token and define a set of parameters surrounding the token. The parameters can restrict or permit the access and use of the token. The parameters may indicate a processing network (e.g., a type and/or specifics of a credit card network); a time to live, which is the period from the moment of issuance until the token expires or is no longer valid (e.g., 30 seconds, 1 minute, 8 hours, 2 days, 1 year, etc.); a scheme/BIN (e.g., debit, credit, prepaid, or token); currency accepted; merchant type (MCC) (e.g., digital goods, travel, online retail store, etc.); merchant information, which may include a choice of merchant preferences such as funding sources, brands, closed loop, dollar limits, etc.; merchant location, which may be the country in which the merchant is registered, terminal location, or whether the merchant is online only or offline only; consumer location radius (e.g., GPS coordinates of the user's mobile device); security features (e.g., cryptogram required or step-up authentication required); routing mechanism (e.g., open or closed loop); type of interaction, which may include funding (e.g., private label credit card (PLCC), points, cards, or banks), identity (e.g., access to hotel, gym or car or other environments that need identity verification), and contextual information (e.g., address, etc.); and amount (e.g., the amount that can be used for payment authorization using the token).

In one embodiment, the TSP 110 can be a stand-alone application, e.g., be hosted by a separate entity from a TSP issuance and transaction system 112, and/or execute independently from execution of the TSP issuance and transaction system 112. In another embodiment, the TSP 110 can be implemented as a part of the TSP issuance and transaction system 112. For example, the TSP 110 can be hosted by the same server(s) as the TSP issuance and transaction system 112. The TSP 110 can share application programming interface (API) with the TSP issuance and transaction system 112. The TSP 110 can be a part of the same entity as the TSP issuance and transaction system 112.

A user device 114 can display a user interface (UI) 116. The UI 116 can display visual elements, such as to initiate the transaction. The UI 116 can receive input from a user, such as a selection from a user. The user device 114 can also receive input from the user via other input elements, such as via a keyboard, mouse, microphone (e.g., from a voice command), among others. The user device 114 can be implemented using a mobile device, a desktop computer, a laptop computer, a wearable, among others.

A service or an application (such as the user application 102) can be hosted by a combination of software and hardware. It is noted that the same term “hosting” is used herein to describe both software hosting and hardware hosting. When software hosting, a software service such as the TSP 110 can be hosted by the TSP issuance and transaction system 112. When hardware hosting, a computing device (such as a server or a user device) can provide resources such as memory, communication, and execution resources for execution of instructions, such as a server that hosts the TSP issuance and transaction system 112.

The provider 108 can be a merchant that provides goods or services to users. For example, the provider 108 can be an online merchant that offers products or services for sale to the user of the user device 114. In this example, the provider 108 can provide an on-line store (not shown) where the user can select, via the UI 116 of the user application 102, a certain product or service to purchase. The merchant's online store can provide functionality for a user to configure a product or a service, and/or place the product or service in a cart to order the product or service. The online store can provide functionality for the user to select a type of payment for the cart, and to submit the payment such that the products in the cart can be shipped to a shipping address specified by the user, or to schedule the service.

The provider 108 can offer this functionality to users at for access via the online store, or by accessing Point-of-Sale (PoS) devices at a physical location where the provider 108 is located. The provider 108 can receive the payment (for the user-selected product/service) from various sources, such as from the processing network 121, from the processing network 119 via the third-party transaction system 104, and/or from the TSP issuance and transaction system 112, among others. The provider 108 can have a payment account at the TSP issuance and transaction system 112 or at the third-party transaction system 104, and thus can receive the payment as a transfer of funds from a buyer's payment account to the merchant payment account at the respective transaction system.

In the example illustrated in FIG. 1, the TSP issuance and transaction system 112 can interface with one or more financial institutions, such as a financial institution 118. Financial institution 118 can provide financial services to users. The financial institution 118 can be implemented as banks, credit unions, other deposit-taking institutions that accept and manage deposits and make loans, and other financial service providers. In some embodiments, the financial institution 118 can include debit and/or credit card networks, e.g., for funding transfer of money between users. In some embodiments, the financial institution 118 may include a provider of purchasing power that is associated with a loyalty program. In one embodiment, the TSP issuance and transaction system 112 can access funds associated with the first payment account (of the TSP issuance and transaction system 112) by accessing the financial institution 118, and transfer these funds to a second payment account of the TSP issuance and transaction system 112 at another financial institution.

In case where the TSP issuance and transaction system 112 is a payment system, the TSP issuance and transaction system 112 can provide transaction resources for payment services, such as a fund transfer (e.g., a transfer of a certain monetary amount), between users. The transaction resources can include payment instruments used to complete payment transactions. The transaction preferences can be associated with the token that is issued by the TSP issuance and transaction system 112. The transaction resources at the TSP issuance and transaction system 112 can include one or more payment accounts for each user. For example, a first user can be associated with a first payment account, and a second user (e.g., the provider 108) can be associated with a second payment account (e.g., a provider payment account) at the TSP issuance and transaction system 112.

The third-party transaction system 104 can act as an intermediary between the user application 102 and the TSP 110/TSP issuance and transaction system 112. The TSP 110 can generate a first type of token (e.g., a link token, which can be one implementation of the link) 149 upon linking of an onboarded representation of the user at the third-party transaction system 104 with an onboarded representations of the user at the TSP issuance and transaction system 112. As discussed below with reference to FIG. 2, the TSP issuance and transaction system 112 can issue a second type of token (e.g., a token 150, such as a payment token) upon receiving a pre-transaction request. The second type of token can facilitate a transaction with a different entity from the first type of token. The TSP 110 can issue different types of tokens, each referencing the same onboarded user representations. Each of the different types of the token can be intended for use by a different entity, as explained further below.

Each of the TSP issuance and transaction system 112 and the third-party transaction system 104 can model its own set of users. In some implementations, the third-party transaction system can include an Identity Provider (IdP) that models it users, including an account for each user, characteristics of that user, authentication privileges, authorization for access to certain resources and services, transaction history, among others. The third-party IdP can include a user representation for the user of the user device 114. Similarly, the TSP issuance and transaction system can include an IdP (i.e., separate from the third-party IdP) that models its users (which can be a different set of users from the users of the third-party transaction system) that also can include a user representation of the user of the user device 114. The IdPs can also model other entities, such as various provider(s) that include the provider 108.

In FIG. 1, a user representation managed by the third-party transaction system 104 can be linked with a user representation, for the same user, at the TSP issuance and transaction system 112. In general, the link 149 (which can be implemented as an account identifier (AID)) can be generated by the TSP 110 prior to receiving a pre-transaction request 202. The TSP 110 can generate the link 149 that indicates linking of the user representations between the third-party transaction system 104 and the TSP issuance and transaction system 112. The link 149 can be provided to the third-party transaction system 104 by the TSP 110.

The TSP issuance and transaction system 112 can be associated with various transaction resources, one or more of which can be used to complete transactions. The TSP issuance and transaction system 112 can associate transaction preferences with a token. The transaction preferences can indicate which of the transaction resources can be used with transactions. The transaction preferences can be used (e.g., as rules) to determine when different transaction resources are selected for use. Many of the examples described herein refer to payment systems. In some embodiments, the TSP issuance and transaction system 112 can implement SaaS functionality, such as to provide secure software services to the user device 114.

FIG. 2A is a system diagram illustrating embodiments of a communication system showing communication for interoperable token transactions between a provider, the transaction system, and/or the third-party transaction system. In some embodiments, the provider 108 can communicate with the TSP issuance and transaction system 112 as part of an in-store PoS transaction, or as part of an in-application transaction (e.g., accessing a merchant's application, such as user application 102, on the user device 114), or as part of an online check-out transaction.

A pre-transaction request 202 can be communicated by the third-party transaction system 104 to the TSP issuance and transaction system 112. The pre-transaction request 202 can be a request for a token from the TSP issuance and transaction system 112. In some embodiments, the pre-transaction request 202 can also indicate a transaction that is being initiated at the user application 102 when accessing some system of the provider 108. For example, the transaction can be for selecting and purchasing a certain service that is offered by the provider 108. In some cases, the provider 108 can use the received token for a transaction that was not indicated by the pre-transaction request 202. In some embodiments, the TSP issuance and transaction system 112 can determine whether a transaction can be performed using a closed-loop token or an open-loop token, and generate an appropriate token type. The token can indicate authentication of the user as well as an account of the user (such as at the processing network 119).

The user application 102 can provide payment for the products or services provided by the provider 108 via the third-party transaction system 104. The third-party transaction system 104 can communicate the pre-transaction request 202 including the link 149 (which can be implemented using an AID and/or a refresh token). Based on the token request and the AID, the TSP issuance and transaction system 112 can issue a requested token. The issued token 150 can be communicated to the third-party transaction system 104. The third-party transaction system 104 can then use the token 150 for a transaction for processing of a transaction (e.g., as requested by the provider 108) at the TSP issuance and transaction system 112.

In some embodiments, the TSP 110 can communicate with the TSP issuance and transaction system 112 to determine whether to provide additional tokens to the third-party transaction system 104. The TSP issuance and transaction system 112 can make this determination based on information received from the TSP 110. Thus, although the TSP 110 isn't shown in FIG. 2, the TSP issuance and transaction system 112 can include (or otherwise access) at least the token generation functionality of the TSP 110. As noted above, the TSP issuance and transaction system 112 can make this determination using the token rules.

The link 149, and any additional tokens originating at the TSP issuance and transaction system 112 can each be used in a different way, depending on the intended destination of initial consumption. For example, the link 149 can be used by the third-party transaction system 104 for accessing resources associated with the user account at the financial institution 118 and/or at the processing network 119.

In some embodiments, the provider 108 can request token issuance from the TSP issuance and transaction system 112 prior to receiving user transaction initiation. In some embodiments, upon receiving indication of transaction initiation, such as from the user application 102 or from the provider 108, the third-party transaction system can communicate the pre-transaction request 202 (that includes the link 149) to the TSP issuance and transaction system 112. Upon receiving the pre-transaction request 202 from the third-party transaction system 104, the TSP issuance and transaction system 112 can process a transaction indicated by the pre-transaction request 202 or issue (e.g., generate and/or transmit) a payment tokens to the third-party transaction system 104. The TSP issuance and transaction system 112 can thus issue different tokens at different times depending on the pre-transaction request and/or an indicated transaction. The determination on what type of additional token(s) to generate can be based on the type of the request.

The transaction rules can be used by the TSP 110, as well as by the TSP issuance and transaction system 112, to determine whether to generate additional token(s) based on a pre-transaction request 202 (or on a subsequent transaction request). For example, the transaction rules can indicate when to generate the token 150 as an open loop token that can be provided to the processing network 119 (without being provided to the third-party transaction system 104), as an closed loop token that can be provided to the third party transaction system 104, or whether not to generate the token 150 at all. Thus, the TSP 110 can determine whether user accounts for a user are onboarded at the third-party transaction system 104 and at the TSP issuance and transaction system. The TSP 110 can provide the link 149, that indicates association between the on-boarded accounts, to the third-party system 104. The third-party system can then use the link 149 as part of the pre-transaction request, as discussed below with reference to FIG. 2.

Token rules can define how tokens are issued by the TSP 110 and/or by the TSP issuance and transaction system 112. The token rules can also indicate how to generate a token with token scope that may limit where the token can be used, such as at which provider. The token rules can indicate which transaction resources can be used for the transaction with the provider 108. The token rules can indicate how to determine if a token (e.g., an additional token) should be generated as a closed loop token or an open loop token. If the token is a closed loop token, the token rules can indicate a transaction system where the closed loop token can be used, such as directly at the TSP issuance and transaction system 112. The issued token can indicate access to various transaction resources at the TSP issuance and transaction system 112.

In some instances, the TSP issuance and transaction system 112 can process the transaction using the link 149, without issuing additional tokens to the third-party transaction system 104. The provider 108 can have an account with the TSP issuance and transaction system 112. The TSP issuance and transaction system 112 can then process the transaction using the link 149 that indicates the association between an account of the user at the third-party transaction system and an account of the user at the TSP issuance and transaction system 112. The TSP issuance and transaction system 112 can determine that the user can access transaction resources that are available at the TSP issuance and transaction system 112. For example, the user can have a balance at the TSP issuance and transaction system 112. The TSP issuance and transaction system 112 can then transfer a certain amount of transaction resources between the account of the user and the account of the provider 108 at the TSP issuance and transaction system 112. In some instances, the TSP issuance and transaction system 112 can issue a closed loop token that is later consumed at the TSP issuance and transaction system 112 to access resources at the TSP issuance and transaction system 112.

In some instances, the TSP issuance and transaction system 112 can issue the token 150 to the third-party transaction system 104 for initial consumption at the third-party transaction system 104. The third-party transaction system 104 could then use the token 150 to process the transaction using the processing network 121. For example, the transaction can be for purchasing a service or a product by the user from the provider 108. The TSP issuance and transaction system 112 can issue the token 150 to the third-party transaction system 104 for initial consumption at the user application 102. The user application 102 can then access the processing network 121 (or another processing network) using use the token 150 to process the transaction using the processing network. In some instances, the provider can have an account with the processing network 119. The TSP issuance and transaction system 112 can then generate another token (e.g., the token 150) that is used to access the processing network 119.

Optionally, upon processing the transaction, the TSP issuance and transaction system 112 can communicate to the third-party transaction system 104 that the payment transaction has been completed. For example, the TSP issuance and transaction system 112 can notify the third-party transaction system 104 that funds for the payment request at the provider 108 have been transferred (e.g., from one or more accounts associated with the user of the user device 114).

FIG. 2B is an example process flow for issuing and providing a token to third party transaction system. In the example of FIG. 2B, a user may, via the user application 102, select a “Buy” button 264 associated with an item displayed by a provider's 108 online store. The online store can receive the user selection to buy the selected item. In response to the user selecting the “Buy” button 264, the provider 108 may send transaction information 256 (e.g., as part of a transaction request) to the third-party transaction system 104. The transaction information 256 may include customer ID of the user, transaction amount for the selected item, and merchant ID of the provider 108. In some embodiments, the third-party transaction system 104 can then communicate a transaction request that includes a token request, data based on the transaction information 256, and the link 149. In some embodiments, a pre-transaction request that includes the “get token” token request can be communicated to the TSP issuance and transaction system 112 prior to communicating the transaction request that includes the transaction information 256.

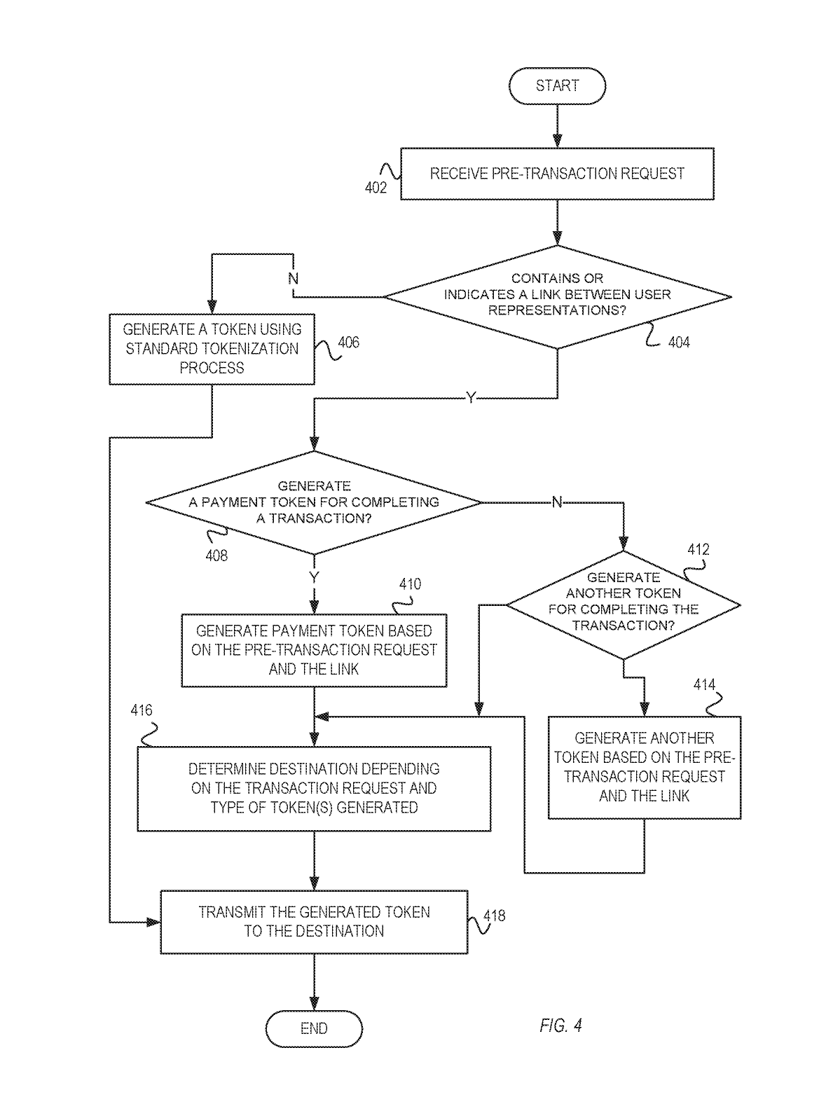

As discussed below with reference to FIG. 4, the TSP issuance and transaction system 112 may generate tokens at least based on the pre-transaction request and the link, where the tokens can be specific to certain processing networks. For example, the TSP issuance and transaction system 112 may issue the token 150, for use at the processing network 121, that includes the user's funding primary account number, token primary account number, dynamic card verification value (e.g., security context), and/or expiration date.

In some embodiments, the following functionality can be used for account linking, token issuance, and token processing. This functionality can be accessed at the TSP issuance and transaction system 112 by the third-party transaction system 104, such as via an API.

Device Registration—Provides ability to register a device where tokens need to be provisioned. This is a part of the linking process. With reference to FIG. 1, the user device 114 can be registered for accessing any tokens that are provisioned (such as at the third-party transaction system). The device registration can be implemented at one or more of steps 308-312.

Enrollment—Provisions users' payment instrument in a wallet providers application. This is a part of the linking process. With reference to FIG. 1, any accounts of the user can be linked between the TSP issuance and transaction system 112 and the third-party transaction system 104.

Provision token—allows a wallet provider to provision tokens for a payment instrument. This is a part of the token issuance process. With reference to FIG. 1, the TSP issuance and transaction system 112 can issue a token 150 to the third-party transaction system 104.

Identity verification—performs risk analysis and verifies the user's identity. This is a part of transaction processing. With reference to FIG. 1, the TSP issuance and transaction system 112 can perform risk analysis on the user.

Token Life Cycle Management—Performs lifecycle operations on the issued token, e.g., the token 150. This is a party of post-transaction processing.

Transaction Details—provides transaction details to the wallet provider, e.g., to the third-party transaction system 104. This is a party of post-transaction processing.

Address and Ping—additional functionality provided to the third-party transaction system 104 as part of post-transaction processing.

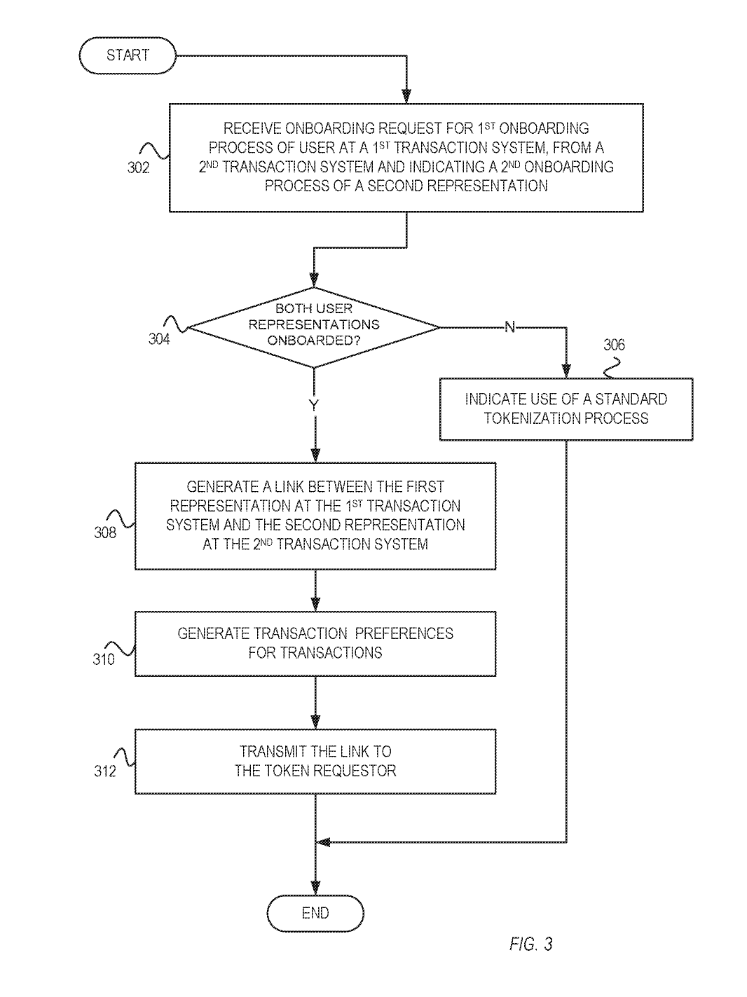

FIG. 3 is a flow diagram illustrating embodiments of operations for linking user representations for interoperable token use as part of onboarding a user account of one transaction system onto another transaction system. The flow diagram of FIG. 3 is described with reference to the systems and components described in FIGS. 1 and 2 (for illustration purposes and not as a limitation). The example operations can be carried out by the TSP 110 and/or by the TSP issuance and transaction system 112.

Beginning with 302, the TSP 110 can receive an onboarding request for a first onboarding process of a first representation of a first user at a first transaction system, such as the TSP issuance and transaction system 112. The onboarding request can be received from a second transaction system, such as the third-party transaction system 104. The request can indicate a second onboarding process of a second representation of the first user at the second transaction system. It is noted that in some embodiments, step 302 can be omitted, and step 304 is performed without receiving an onboarding request. For example, the step 304 can be performed to check whether a previous account onboarding process has been properly performed. The onboarding process can also be performed automatically for some or all accounts that have common users in common between the two transaction systems. The onboarding request can also be made for one-way association of an account—i.e., at one of the transaction systems. The on-boarding request can indicate the user device 114.

At 304, the TSP 110 determines whether both user representations are onboarded. If the TSP 110 determines that both user representations are onboarded, the flow continues at 308, otherwise the flow continues at 306. The TSP 110 can make this determination by communicating with the TSP issuance and transaction system 112 and/or with the third-party transaction system 104. In some embodiments, the TSP 110 can access own database that includes onboarding data for the transaction systems.

At 306, the TSP 110 indicates use of a standard tokenization process. The standard tokenization process can include indicating using a single open or closed loop token to the third-party transaction system 104, without generating and/or transmitting a link token to the third-party transaction system 104 (or to another entity). The standard tokenization process, as shown in FIG. 4, can also include generating a single open or closed loop token to the third-party transaction system 104 that is not based on the link 149.

At 308, the TSP 110 generates a link between the first representation at the first transaction system and the second representation at the second transaction system. Linking of user representations at the two transaction systems 104 and 112 can include mapping of user representations (for the same user) between the transaction systems 104 and 112. Linking of the user representations between the two transaction systems 104 and 112 can include exchanging registration and configuration information for the user. The linking can include receiving authorization, from the third-party transaction system (such as from each respective IdP), to change a certain transaction resource, at the TSP issuance and transaction system 112, for subsequent tokens generated at the TSP issuance and transaction system 112. In some embodiments, the TSP can perform the device registration process for the user device 114.

In some embodiments, the TSP 110 can generate an identity handle indicating the link between the first representation at the first transaction system and the second representation at the second transaction system. An Account Identifier (AID) can serve as the identity handle for the TSP transactions system 112 while integrating with the IdP of the third-party transaction system 104. During the linking process, the third-party transaction system 104 can send its own identity handle of the same user within the IdP of the third-party transaction system 104. On a successful completion of the identity linking, the TSP 110 can link the AID to the corresponding identity handle of the third-party transaction system 104. The link 149 can indicate the successful completion of the identity linking process. The identity linking process can also include the enrollment functionality discussed above.

The TSP issuance and transaction system 112 can generate the link by associating a first identity handle (that represents the user in the TSP issuance and transaction system 112) with a second identity handle that represents the same user in the third-party transaction system 104. The TSP issuance and transaction system 112 can determine that user consent necessary for generation of the link (i.e., proper user authorization) is obtained from the TSP issuance and transaction system 112 based on the user accounts and associated data, including any prior authentications for the user. However, in some embodiments, the TSP issuance and transaction system 112 can determine that user consent necessary for generation of the link requires a redirect, to the user device 114 associated with the user via the third-party transaction system 104 to obtain the user consent.

At 310, the TSP 110 generates transaction preferences for transactions. The transaction preferences can indicate which of transaction resources can be used with certain types of transactions. The transaction resources can include accounts accessible via the processing network 121, accounts at the financial institution, and/or accounts accessible via the processing network 119, as well as any resource accounts at the TSP issuance and transaction system 112.

At 312, the TSP 110 transmits the link to the token requester. The transmitted link can be implemented as a link token 149. The transmitted link can be implemented as an identity handle 149 that points to the user account at the IdP of the TSP issuance and transaction system 110. The transmitted link can be implemented as an indication 149 of successful linking.

FIG. 4 is a flow diagram illustrating embodiments of operations for token issuance and processing a pre-transaction request that includes a link token. The flow diagram of FIG. 4 is described with reference to the systems and components described in FIGS. 1 and 2 (for illustration purposes and not as a limitation). The example operations can be carried out by the TSP 110 and/or by the TSP issuance and transaction system 112. FIG. 4 can implement at least portion of the provision token functionality discussed above.

Beginning with 402, the TSP issuance and transaction system 112 receives a pre-transaction request 202 for a transaction. The pre-transaction request can indicate a transaction type that indicates a potential origin of a requested transaction. The pre-transaction request can include a token request for a token (which can be returned to the third-party transaction system 104). In some embodiments, the TSP issuance and transaction system 112 can model a plurality of users of the TSP issuance and transaction system 112, as well as any users of the third-party transaction system 104 that are linked to corresponding users of the TSP issuance and transaction system 112. The TSP issuance and transaction system 112 can model a plurality of users of the provider 108 that are associated with corresponding users of the TSP issuance and transaction system 112.

In subsequent transaction calls, it may be sufficient for the third-party transaction system 104 to communicate the link 149. In some embodiments, at 402 the third-party transaction system 104 can communicate its own identity handle instead of the link 149 to initiate the transaction process. The TSP issuance and transaction system 112 can then determine the linking based on the received identity handle of the third-party transaction system 104. Each link 149 and/or identity handle can be associated with different scopes, e.g., that include transaction preferences. The TSP issuance and transaction system 112 can initiate authenticated processing of a requested transaction for the linked accounts without needing oAuth 2.0 tokens, billing agreement IDs, or similar tokens. Thus, the transaction can be initiated as an authenticated transaction at TSP issuance and transaction system 112 by receiving the pre-transaction request 202 with just an identity handle of the user at the third-party transaction system 104.

At 404, the TSP issuance and transaction system 112 determines whether the pre-transaction request contains or indicates a link between user representations. If the TSP issuance and transaction system 112 determines that the pre-transaction request contains or indicates the link, the flow continues at 408, otherwise the flow continues at 406.

At 406, the TSP issuance and transaction system 112 generates a token using a standard tokenization process. The standard tokenization process can include generating a single or multiple open or closed loops token to the third-party transaction system 104 independently of the link 149. The TSP issuance and transaction system 112 can thus provision the token for a certain payment instrument.

At 408, the TSP issuance and transaction system 112 determines whether to issue a payment token for completing the transaction. If the TSP issuance and transaction system 112 determines to issue the payment token, the flow continues at 410, otherwise the flow continues at 412. The payment token can authorize access, via the first transaction system, to transaction resources at a third transaction system using the first representation. The TSP issuance and transaction system 112 can determine whether to generate the payment token as an open loop token or a closed loop token. In some embodiments, the TSP issuance and transaction system 112 can determine whether to generate multiple tokens, comprising the payment token, of a requested transaction. This determination can be made based on the pre-transaction request, user preferences, and any selection made by the user (e.g., via the UI 116).

The transaction can be performed using one of several options, such as via one of user's accounts at the financial institution 118, or via another one of the user's accounts at the processing network 121 as onboarded at the third-party transaction system 104. Access to each of these accounts requires a different type of a token, each of which having a different destination.

At 410, the TSP issuance and transaction system 112 generates the payment token based on the pre-transaction request and the link. In some embodiments, the TSP issuance and transaction system 112 can generate a bundle that includes the payment token. The payment token can indicate an association with an initial financial transaction resource, or a collection of transaction resources, at the TSP issuance and transaction system 112. The TSP issuance and transaction system 112 can access token rules to determine token scope that indicates potential variations in token parameters (e.g., the generation of the token can be based on the token scope). In some embodiments, the TSP issuance and transaction system can generate multiple tokens (including the payment token) for interoperable use at various processing entities for completing a requested transaction, where each of the multiple tokens is associated with the link 149.

For example, the token scope may be based on the preference(s) of the TSP 110. The TSP 110 may modify the token scope to optimize certain objectives or needs (e.g., lower cost, lower risk, and/or higher revenue, among others). The TSP issuance and transaction system 112 may issue a token having a more favorable interchange to certain merchants or partners based on preferred pricing details. In another example, if a consumer (e.g., the user) desires to pay with a closed loop gift card, the TSP issuance and transaction system 112 may issue a click fee-based token to save on any interchange fees. In another example, for a high-risk merchant or a high-risk consumer, the TSP issuance and transaction system 112 may decline issuance of the token based on past behavior of the consumer.

In another example, the token scope may be based on a regulatory need. The TSP issuance and transaction system 112 may issue tokens with its scope adjusted to meet certain country-specific regulatory or compliance needs. For example, if a particular country requires the use of a cryptogram with the token, the TSP issuance and transaction system 112 may, when issuing a token to provider 108 located in that particular country, issue a token with a cryptogram. In another example, if there is a regulatory-based limit on a currency amount a token can represent, the TSP issuance and transaction system 112 would use this regulatory-based limit during token generation. In another example, the Durbin Amendment in the United States requires the Federal Reserve to limit fees charged to retailers for debit card processing. Accordingly, the TSP issuance and transaction system 112 may switch the type of token being issued if the consumer is using a regulated debit card in her wallet so that certain rates are not charged to the provider 108.

The TSP issuance and transaction system 112 can thus generate the token representing the transaction. The generated token can include an expiration date, a token identifier, and/or a security context, among others. In some examples, the security context can be implemented using a security code. The token identifier can be implemented using a number that identifies the token. In some implementations, the token identifier is not an actual credit card or debit card number, and can be thought of as a “transactable primary account number” (TPAN). The token can be used, such as by the provider 108, to obtain funding for the transaction from the user's linked funding source. In some embodiments, the token can be replaced with a cryptogram to provide additional security.

At 412, the TSP issuance and transaction system 112 determines whether to generate another token for completing the transaction. If the TSP issuance and transaction system 112 determines to generate another token, the flow continues at 414, otherwise the flow continues at 416. At 414, the TSP issuance and transaction system 112 generates another token based on the pre-transaction request and the link. At 414, the TSP issuance and transaction system can generate multiple tokens for interoperable use at various processing entities for transaction completion, where each of the multiple tokens is associated with the link 149. At 414, the token is generated based on token type and destination determination at 412.

At 416, the TSP issuance and transaction system 112 determines a destination depending on the pre-transaction request and type of token(s) generated. The destination may indicate intended initial consumption of the token, which can be the third-party transaction system, the provider 108, or the user application 102. If the flow is from 410, then the destination can be determined at step 408 or 410. If the flow is from 414, the TSP issuance and transaction system can determine the destination of the other token as determined at 412 or 414. If the flow is from 412, then the TSP issuance and transaction system 112 can use the AID without using any tokens.

At 418, the TSP issuance and transaction system 112 transmit the generated token to the destination. The TSP issuance and transaction system 112 can determine whether to communicate with the provider 108 directly using the payment token for completing the requested transaction. In this scenario, the provider 108 can then use the payment token to access the processing network 121 for completing the transaction. For some closed loop tokens, any transactions using the closed loop token can only be performed at the TSP issuance and transaction system 112.

For some types of transactions, the pre-transaction request with the link 149 is sufficient to process the transaction at the TSP issuance and transaction system 112, without issuing the token 150. If the TSP issuance and transaction system 112 is a payment system, the pre-transaction request can be for funding a purchase made at the provider 108. If the TSP issuance and transaction system 112 is an SaaS system, the pre-transaction request can be for using a certain software component/services of a certain software component at the user device 114. The TSP issuance and transaction system 112 can process the transaction indicated by the pre-transaction request 202 based on the transaction preferences, including accessing accounts at the financial institution 118. In some embodiments, the TSP issuance and transaction system 112 can issue and use a token with the processing network 119, without communicating the token to the third-party transaction system 104.

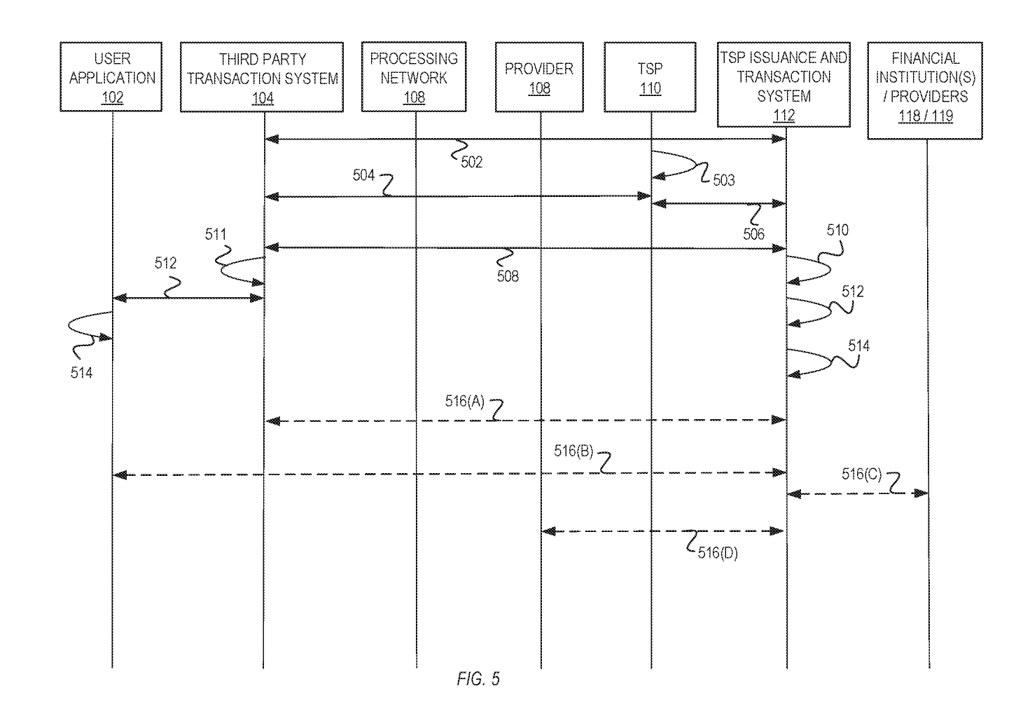

FIG. 5 is a timing diagram illustrating establishing communication between transaction systems for interoperable token use. As shown by FIG. 5, the user application 102 communicates with the third-party transaction system 104 and the provider 108. The third-party transaction system 104 communicates with the user application 102, the provider 108, the processing network 121, and the TSP issuance and transaction system 112. The TSP issuance and transaction system 112 communicates with the TSP 110, the provider 108, the third-party transaction system 104, and the financial institution/processing network 118 and 119. The communications of FIG. 5 can be performed over one or more communication networks. Portions of the timing diagram of FIG. 5 correspond to the flow diagrams of FIGS. 3 and 4.

At 502, the TSP issuance and transaction system 112 can communicate with the third-party transaction system 104 to link user accounts the two transactions systems (e.g., at one or more of steps 302 and 304). At 503, the TSP 103 can generate user the link and preferences for transactions with the third-party transaction system 104 (e.g., at one or more of steps 308 and 310). At 504, the TSP 110 can communicate the link 149 to the third-party transaction system 104 (e.g., at step 312). At 506, the TSP 110 can communicate with the TSP issuance and transaction system 112, such as to provide token rules for token generation, as well as information related to the link including the user accounts, transaction preferences, among others.

At 508, the TSP issuance and transaction system 112 can receive a pre-transaction request from the third-party transaction system, where the pre-transaction request can include the link (e.g., at step 402). At 510, the TSP issuance and transaction system 112 can determine whether the pre-transaction request indicates a link between user representations (e.g., at step 404). At 510, the TSP issuance and transaction system 112 can also determine whether to generate the payment token or another type of token (e.g., at steps 408 and 412). At 512, the TSP issuance and transaction system 112 can generate the payment token or other token(s) (e.g., at steps 410 or 412). As discussed above, in some cases the TSP issuance and transaction system 112 would use the link to process the transaction, without generating the token(s).

At 514, the TSP issuance and transaction system 112 can determine the destination based on the generated token(s) and the requested transaction. At 516(A)-516(D), the TSP issuance and transaction system 112 can transmit the generated token to the destination (as determined based on the type of token(s) generated). As shown by FIG. 5, the TSP issuance and transaction system 112 can communicate a payment token 516(A) to the third-party transaction system 104. Alternatively, the TSP issuance and transaction system 112 can communicate a token 516(B) to the user application 102 (directly or via the third-party transaction system 104). Alternatively, the TSP issuance and transaction system 112 can communicate a token 516(C) directly with the financial institutions/providers 118/119. Alternatively, the TSP issuance and transaction system 112 can communicate a token 516(D) to the user application 102 (directly or via the third-party transaction system 104).

Some Examples of Transaction Processing Using Interoperable Token Use

In one example, the pre-transaction request can be for the user of the TSP issuance and transaction system 112 to access the provider 108 via the third-party transaction system 104. In this example, the provider is an entity that can be managed by the IdP of the third-party transaction system 104. After the link 149 is provided to the third-party transaction system 104 (during on-boarding of the user), the third-party transaction system 104 can use the link 149 for the transaction (e.g., as a part of the pre-transaction request 202) to initiate the transaction. The transaction can be performed at the TSP issuance and transaction system 112 using the link 149, without generating any additional tokens (i.e., without generating and using the token 150). For example, this use case can apply to YOUTUBE accounts (i.e., the provider 108) that are managed by GOOGLE (i.e., the third-party transaction system). The GOOGLE accounts for YOUTUBE could be linked to a PAYPAL transaction system (i.e., the TSP issuance and transaction system 112), including communication of the link 149 to the third-party transaction system 104. Any YOUTUBE transactions (such as monthly subscription fees) for a certain user, could be processed using the link 149.

In another example, the transaction system can be used for the user of the third-party transaction system 104 to access the provider 108 that is an entity that can be managed by the IdP of the TSP issuance and transaction system 112. Based on the pre-transaction request 202 and optionally user and/or provider preferences, the TSP issuance and transaction system 112 can generate the token 150 (which can be a closed loop token) with destination of the provider 108. The token 150 can be communicated to the third-party transaction system 104, which can forward the token 150 to the provider 108. The provider 108 can then access the TSP issuance and transaction system 112 with the actual transaction and the token 150 to process the transaction. The token 150 can then be used to access the financial institution 121. For example, this use case can apply to a third-party merchant accounts (i.e., the provider 108) that are managed by GOOGLE (i.e., the third-party transaction system). The GOOGLE accounts for the merchant could be linked to a PAYPAL transaction system (i.e., the TSP issuance and transaction system 112), including communication of the link 149 to the third-party transaction system 104. Any merchant transactions (such as individual purchases) for a certain user, could be processed using a pre-transaction request that would in turn generate the payment token 150, which would be used to access the processing network 121. This is an example of issuance and processing of closed loop tokens, where the provider can be the merchant of record (MOR).

In another example, the transaction system can be used for the user of the third-party transaction system 104 to access the provider 108 that is an entity that can be managed by the IdP of the third-party transaction system (but without integration with the TSP issuance and transaction system). Based on the pre-transaction request 202 and optionally user and/or provider preferences, the TSP issuance and transaction system 112 can generate the token 150 (which can be an open loop token) with destination of the provider 108. The token 150 can be communicated to the third-party transaction system 104, which can forward the token 150 to the provider 108. The provider 108 can then access the processing network 121 using the actual transaction and the open loop token. It is noted that similar processing can be performed for transactions that are detected to be initiated in-store, i.e., at a physical location of the provider 108. This use case can be similar to the one discussed above, except that the generated token 150 can be an open-loop token. This is an example of issuance and processing of open loop tokens, where a third-party merchant is not the MOR.

It should be understood that FIGS. 1-5 and the operations described herein are examples meant to aid in understanding embodiments and should not be used to limit embodiments or limit scope of the claims. Embodiments may perform additional operations, fewer operations, operations in a different order, operations in parallel, and some operations differently. For example, one or more elements, steps, or processes described with reference to the diagrams of FIGS. 3-5 may be omitted, described in a different sequence, or combined as desired or appropriate.

As will be appreciated by one skilled in the art, aspects of the present disclosure may be embodied as a system, method, or computer program product. Accordingly, aspects of the present disclosure may take the form of an entirely hardware embodiment, a software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible and/or non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Computer program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object-oriented programming language such as Java, Smalltalk, C++ or the like and conventional procedural programming languages, such as the “C” programming language or similar programming languages. The computer program code may execute (e.g., as compiled into computer program instructions) entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flow diagram illustrations and/or block diagrams of methods, apparatus (systems) and computer program products according to embodiments of the present disclosure. It will be understood that each block of the flow diagram illustrations and/or block diagrams, and combinations of blocks in the flow diagram illustrations and/or block diagrams, can be implemented by computer program instructions. These computer program instructions may be provided to a processor of a general purpose computer, special purpose computer, or other programmable data processing apparatus to produce a machine, such that the computer program instructions, which execute via the processor of the computer or other programmable data processing apparatus, create means for implementing the functions/acts specified in the flow diagrams and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flow diagram and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flow diagrams and/or block diagram block or blocks.

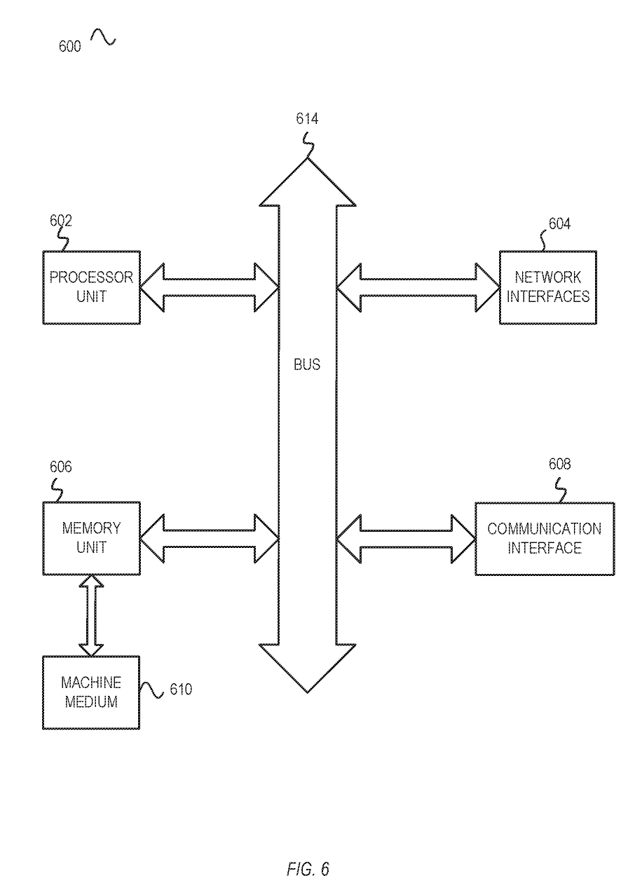

FIG. 6 is a block diagram of an exemplary embodiment of an electronic device 600 including a communication interface 608 for network communications. The electronic device can embody functionality to implement embodiments described in FIGS. 1-5 above. In some implementations, the electronic device 600 may be a laptop computer, a tablet computer, a mobile phone, a powerline communication device, a smart appliance (PDA), a server, and/or one or more other electronic systems. For example, a user device may be implemented using a mobile device, such as a mobile phone or a tablet computer. For example, a payment system may be implemented using one or more servers. The electronic device 600 can include a processor unit 602 (possibly including multiple processors, multiple cores, multiple nodes, and/or implementing multi-threading, etc.). The electronic device 600 can also include a memory unit 606. The memory unit 606 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The electronic device 600 can also include the bus 610 (e.g., PCI, ISA, PCI-Express, HyperTransport®, InfiniBand®, NuBus, AHB, AXI, etc.), and network interfaces 604 can include wire-based interfaces (e.g., an Ethernet interface, a powerline communication interface, etc.). The communication interface 608 can include at least one of a wireless network interface (e.g., a WLAN interface, a Bluetooth interface, a WiMAX interface, a ZigBee interface, a Wireless USB interface, etc.). In some implementations, the electronic device 600 may support multiple network interfaces—each of which is configured to couple the electronic device 600 to a different communication network.

The memory unit 606 can embody functionality to implement embodiments described in FIGS. 1-5 above. In one embodiment, the memory unit 606 can include one or more of functionalities for interoperable token use in transaction systems. Any one of these functionalities may be partially (or entirely) implemented in hardware and/or on the processor unit 602. For example, some functionality may be implemented with an application specific integrated circuit, in logic implemented in the processor unit 602, in a co-processor on a peripheral device or card, etc. Further, realizations may include fewer or additional components not illustrated in FIG. 6 (e.g., video cards, audio cards, additional network interfaces, peripheral devices, etc.). The processor unit 602, the memory unit 606, the network interface 604 and the communication interface 608 are coupled to the bus 610. Although illustrated as being coupled to the bus 610, the memory unit 606 may be coupled to the processor unit 602.

While the embodiments are described with reference to various implementations and exploitations, it will be understood that these embodiments are illustrative and that the scope of the present disclosure is not limited to them. In general, techniques for interoperable token use in transaction systems as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the present disclosure. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the present disclosure.

What is claimed is:

1. A method for interoperable token issuance and use in transaction processing, the method comprising:
receiving an onboarding request for a first onboarding process of a first representation of a first user at a token issuance and transaction system, the request received from a transaction system, the request indicating a second onboarding process of a second representation of the first user at the transaction system;
generating, based on performing the first onboarding process and receiving an indication of success of the second onboarding process, a link between the first representation at the token issuance and transaction system and the second representation at the transaction system;
receiving a pre-transaction request from the transaction system, the pre-transaction request indicating a transaction type and the link between the first and second representations; and
determining, based on the link, whether to generate a payment token for completing a requested transaction corresponding to the pre-transaction request.

2. The method of claim 1, wherein said generating the link comprises:
generating an identity handle indicating the link between the first representation at the token issuance and transaction system and the second representation at the transaction system; and
transmitting the identity handle to the transaction system, wherein said determining whether to generate the payment token is further based receiving the identity handle via the pre-transaction request.

3. The method of claim 1, wherein said generating the link comprises associating a first identity handle representing the user in the token issuance and transaction system with a second identity handle representing the user in the transaction system.

4. The method of claim 1, wherein the payment token authorizes access, via the token issuance and transaction system, to transaction resources at another transaction system using the first representation.

5. The method of claim 1, wherein the transaction type indicates origin of the requested transaction and an expected token for returning to the transaction system.

6. The method of claim 1, wherein said determining whether to generate the payment token comprises determining whether to generate multiple tokens, comprising the payment token, for completing the requested transaction.

7. The method of claim 6, further comprising
generating the multiple tokens for interoperable use at various processing entities for completing the requested transaction, wherein each of the multiple tokens is associated with the link.

8. The method of claim 1, further comprising:
determining that user consent necessary for generating the link is obtained from the token issuance and transaction system; and
providing a redirect, to a user device associated with the user via the transaction system to obtain the user consent.

9. The method of claim 1, wherein the requested transaction is received from a provider of a service to a user device associated with the user, wherein a plurality of the users, including the user, of the provider are modeled using the token issuance and transaction system.

10. The method of claim 1, further comprising:
determining whether to communicate with a provider of the requested transaction directly using the payment token for completing the requested transaction.

11. A token issuance and transaction system comprising:
a non-transitory memory storing instructions; and
a processor configured to execute the instructions to cause the token issuance and transaction system to:
generate a link between a first representation of a user and a second representation of the user at a transaction system;
receive a pre-transaction request from the transaction system, the pre-transaction request indicating a transaction type and an account identifier of the transaction system that indicates the link between the first and second representations; and
determine, based on the link, whether to generate one or more tokens for interoperable use by the transaction system, each of the token(s) for use for a different transaction type.

12. The token issuance and transaction system of claim 11, wherein executing the instructions further causes the token issuance and transaction system to:
generate a refresh token indicating the link; and
communicate the refresh token to the transaction system.

13. The token issuance and transaction system of claim 12, wherein said determining, based on the link, whether to generate the one or more tokens comprises determining whether to generate an additional token for use by the transaction system instead of the refresh token; whether the additional token is usable for a first transaction type and the refresh token is usable for a second transaction type.

14. The token issuance and transaction system of claim 11, wherein said generating the link comprises:
generating an identity handle indicating the link between the first representation and the second representation at the transaction system; and
transmitting the identity handle to the transaction system, wherein said determining whether to generate the payment token is further based receiving the identity handle via the pre-transaction request.

15. The token issuance and transaction system of claim 11, wherein said generating the link comprises associating a first identity handle representing the user in the token issuance and transaction system with a second identity handle representing the user in the transaction system.

16. A non-transitory machine-readable medium having instructions stored thereon, the instructions executable to cause performance of operations comprising:
receiving an onboarding request for a first onboarding process of a first representation of a first user at a token issuance and transaction system, the request received from a transaction system, the request indicating a second onboarding process of a second representation of the first user at the transaction system;
based on performing the first onboarding process and receiving an indication of success of the second onboarding process, generating a link between the first representation at the token issuance and transaction system and the second representation at the transaction system;
receiving a pre-transaction request from the transaction system, the pre-transaction request indicating a transaction type and the link between the first and second representations; and
determining, based on the link, whether to generate a payment token for completing a requested transaction corresponding to the pre-transaction request.

17. The non-transitory machine-readable medium of claim 16, wherein said generating the link comprises:
generating an identity handle indicating the link between the first representation at the token issuance and transaction system and the second representation at the transaction system, and
transmitting the identity handle to the transaction system, wherein said determining whether to generate the payment token is further based receiving the identity handle via the pre-transaction request.

18. The non-transitory machine-readable medium of claim 16, wherein said generating the link comprises associating a first identity handle representing the user in the token issuance and transaction system with a second identity handle representing the user in the transaction system.

19. The non-transitory machine-readable medium of claim 16, wherein the operations further comprise:
determining that user consent necessary for generating the link is obtained from the token issuance and transaction system; and
providing a redirect to a user device associated with the user via the transaction system to obtain the user consent.

20. The non-transitory machine-readable medium of claim 16, wherein the operations further comprise:
determining whether to communicate with a provider of the requested transaction directly using the payment token for completing the requested transaction.
